(19) United States
(12) Patent Application Publication
(10) Pub. No.: US 2021/0135504 A1
(43) Pub. Date: May 6, 2021

(54) POWER TRANSMISSION SYSTEM

(71) Applicant: TOSHIBA TEC KABUSHIKI KAISHA, Tokyo (JP)

(72) Inventors: Masakazu KATO, Numazu Shizuoka (JP); Sadatoshi OISHI, Fuji Shizuoka (JP)

(21) Appl. No.: 17/008,539

(22) Filed: Aug. 31, 2020

(30) Foreign Application Priority Data
Nov. 1, 2019 (JP) 2019-199717

(51) Int. Cl. H02J 50/40; H02J 50/12; H02J 7/02; H02J 50/80; B62B 3/14

(52) U.S. Cl. CPC H02J 50/40; H02J 50/12; B62B 3/1424; H02J 50/80; B62B 3/1404; H02J 7/02

(57) ABSTRACT

A power transmission system includes a base unit that includes a guide rail extending along a first direction for guiding a cart, and a plurality of first recesses separated from each other at first predetermined intervals along the guide rail. The power transmission system further includes a plurality of power transmitters attached to the respective first recesses. Each of the first recesses is positioned such that the corresponding power transmitter faces a power receiver of a cart guided along the guide rail.

### CROSS-REFERENCE TO RELATED APPLICATIONS

This application is based upon and claims the benefit of priority from Japanese Patent Application No. 2019-199717, filed on Nov. 1, 2019, the entire contents of which are incorporated herein by reference.

### FIELD

Embodiments described herein relate generally to a power transmission system.

### BACKGROUND

In recent years, a power transmission system has been developed for charging a battery mounted on a cart or the like using a non-contact power transmission technique. For example, such a power transmission system wirelessly transmits power to a power reception system installed in a shopping cart used by a customer in a store. In the non-contact power transmission, the power that has been transmitted from a power transmission coil is received by a power reception coil.

In a power transmission system for charging a battery mounted on each cart in a non-contact manner, the power is transmitted towards a power reception coil mounted on the cart. Normally, batteries are charged in a state where the carts are stored and arranged in a designated storage location. For the power to be transmitted towards each power reception coil, the power transmission coils need to be arranged side by side on the floor surface in accordance with the storage positions of the carts. Such an arrangement tends to be complicated, and thus requires great time and effort for installation of the system and maintenance thereof. For this reason, there is a need for a wireless power transmission system that can be easily installed and maintained.

### BRIEF DESCRIPTION OF THE DRAWINGS

FIG. 1 is a perspective view of a shopping cart equipped with an electronic device powered by a power transmission system according to an embodiment.

FIG. 2 is a perspective view of shopping carts equipped with power reception systems and stored in a storage position.

FIG. 3 is a perspective view of a power transmission system according to an embodiment.

FIG. 4 is a block diagram of a control system for a power transmission/reception system according to an embodiment.

FIG. 5 is a perspective view of a base unit in a power transmission system according to an embodiment.

FIG. 6 is a perspective view of a power transmitter incorporated in a base in a power transmission system according to an embodiment.

FIG. 7 is a diagram for describing a power transmitter and a base in a power transmission system according to an embodiment.

FIG. 8 is a perspective view of an individual power transmission unit in a power transmission system according to a modified example.

FIG. 9 is a perspective view of a connection member for connecting front and rear power transmission units in a power transmission system according to a modified example.

FIG. 10 is a perspective view of a connection member for connecting front and rear power transmission units in a power transmission system according to a modified example.

### DETAILED DESCRIPTION

In general, a power transmission system includes a base unit that includes a guide rail extending along a first direction for guiding a cart. The base unit has a plurality of first recesses separated from each other at first predetermined intervals along the guide rail. The power transmission system further includes a plurality of power transmitters attached to the respective first recesses. Each of the first recesses is positioned such that the corresponding power transmitter faces a power receiver of a cart guided along the guide rail.

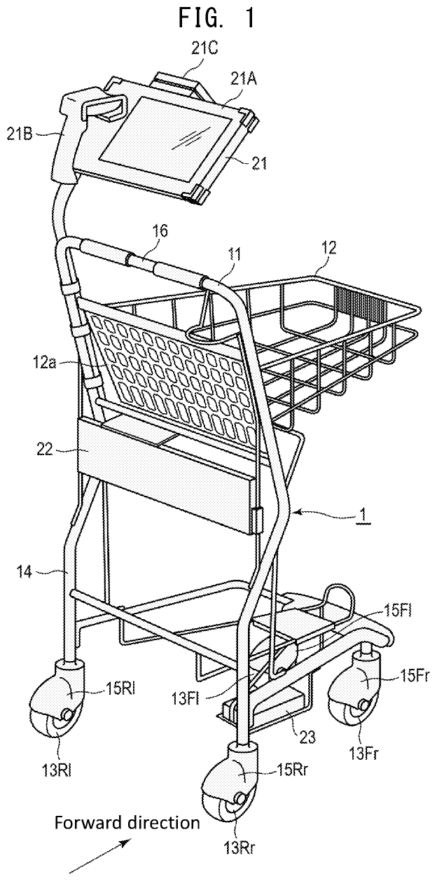

Hereinafter, a power transmission system according to an embodiment will be described with reference to the drawings. FIG. 1 is a perspective view of a shopping cart 1 (hereinafter, simply referred to as a cart) equipped with a power reception system that receives power from a power transmission system in a non-contact manner. A power transmission/reception (non-contact power supply) system includes the power transmission system (power transmission device) that transmits power and the power reception system (power reception device) that receives the transmitted power in a non-contact manner.

The cart 1 is a movable body equipped with the power reception system that receives power transmitted from the power transmission system. The power reception system is mounted on the cart 1 and receives power transmitted in a non-contact manner. For example, the power reception system supplies power that has been received in a non-contact manner to an electronic device or a battery mounted on the cart 1. The power transmission system transmits the power to the power reception system mounted on the cart 1. For example, the power transmission system is arranged so as to transmit the power to the power reception system mounted on the cart 1 stored in a storage position (e.g., a cart storage space).

For example, the battery charged by the power reception system mounted on the cart 1 supplies electric power to the electronic device mounted on the cart 1. The battery charged by the power reception system may be included in the electronic device mounted on the cart 1. The battery charged by the power reception system may be mounted on the cart 1 outside the electronic device and may supply power to the electronic device.

As shown in FIG. 1, the cart 1 includes an electronic device 21, a battery 22, and a power receiver 23 which are attached to a cart body 11 that is movable with a commodity stored therein. The cart body 11 stores a commodity to be purchased by a user. The electronic device 21 is a device for providing information and a service to the user. The battery 22 supplies power to the electronic device 21. The power receiver 23 receives power transmitted from the power transmission system in a non-contact manner. The power receiver 23 charges the battery 22 with the received electric power.

The battery 22 may be a power supply device provided inside the electronic device 21 and having a charge circuit for charging a rechargeable battery cell by electric power received by the power receiver 23. In such a case, the battery 22 supplies the electric power stored in the rechargeable battery cell to the electronic device 21. FIG. 1 shows an outer case of the battery 22, and one or more battery cells or battery packs are disposed in the battery case.

The cart body 11 has a storage basket 12 for storing commodities. The storage basket 12 is supported by a frame 14 provided with four casters 15 (15Fr, 15Fl, 15Rr and 15Rl). The four casters 15 are provided at four corners of the lower portion of the frame 14. The casters 15 (15Fr, 15Fl, 15Rr and 15Rl) respectively include front wheels 13Fr and 13Fl and rear wheels 13Rr and 13Rl that are rotatable. The cart body 11 moves by the wheels 13 of the casters 15 rotating on the floor surface. Further, each of the casters 15 rotates about the vertical axis so that the user can freely change the movement direction.

A handle 16 is provided on a near side of the storage basket 12 in the frame 14. The handle 16 can be gripped by a user. For example, the user grips the handle 16 and moves the cart body 11. In this disclosure, a direction from the handle 16 toward the storage basket 12 is called the “forward direction”. When the cart 1 is stored at the storage position, the front wheels 13Fr and 13Fl are guided along the guide rails 31 (31Fl and 31Fr) and a guide base 32 which will be described later.

Further, the lower portions of the frame 14 in which the four casters 15 are provided at the four corners are narrower on the front side and wider on the rear side in the forward direction. For this reason, the casters 15Fr and 15Fl that support the front wheels have a smaller width than that of the casters 15Rr and 15Rl that support the rear wheels. Thereby, a plurality of carts is stored in a nested manner such that the frame of the rear cart are stored along the frame of the front cart.

Further, the handle 16 side of the storage basket 12 is referred to as the “near side”, and the front side of the cart which is an opposite side to the handle 16 side is referred to as the “front end side”. The storage basket 12 has an opening/closing surface 12a, the lower end of which opens towards the forward direction. Further, the storage basket 12 is formed so that the front end side is smaller than the opening/closing surface 12a. Accordingly, when a plurality of carts are stored in a nested manner, the rear cart pushes up the opening/closing surface 12a of the front cart, and those storage baskets 12 are overlapped each other.

The electronic device 21 is attached to the cart body 11. As shown in FIG. 1, the electronic device 21 is attached to the handle 16 of the cart 1. The electronic device 21 is driven by the electric power supplied from the battery 22. For example, the electronic device 21 is an information terminal such as a tablet terminal for providing information to a user, a commodity reader for acquiring information of a commodity selected by the user, and a card reader for reading a credit card or a membership card or the like. Further, the electronic device 21 may be a charging device for charging a mobile terminal (such as, a mobile phone, a smartphone, a digital camera or the like) owned by the user, using the power supplied from the battery 22.

In the example illustrated in FIG. 1, the electronic device 21 includes a tablet terminal 21A, a commodity reader 21B and a card reader 21C. The tablet terminal 21A is a computer having a display unit on which a touch panel is provided. The tablet terminal 21A is installed with the display unit facing the user who is standing on the handle side. For example, the tablet terminal 21A displays information on commodities read by the commodity reader 21B. Further, the tablet terminal 21A may perform a settlement process on the commodities that have been registered by the commodity reader 21B.

The commodity reader 21B is a device for reading information about a commodity. The commodity reader 21B may include a display unit that displays the information on the read commodity. For example, the commodity reader 21B is a scanner that reads commodity identification information such as a barcode attached to a commodity that is put in and out of the storage basket 12. Further, the commodity reader 21B may be an RFID (Radio-frequency Identification) tag reader that reads an RFID tag attached to a commodity. The commodity reader 21C is a card reader for reading a credit card, a membership card or the like owned by a user.

Additionally, an interface device for connecting a mobile terminal (a smartphone, a tablet terminal, or the like) owned by the user may be provided instead of the tablet terminal 21A. The mobile terminal connected to the interface device as the electronic device 21 may perform the same processing as that of the tablet terminal 21A described above. Further, the interface device as the electronic device 21 may charge the mobile terminal. The interface device may incorporate the battery 22, or may be installed separately from the battery 22.

The power receiver 23 is attached to a bottom portion of the cart body 11. The power receiver 23 installed on the bottom portion of the cart body 11 receives electric power transmitted from below the cart body 11 in a non-contact manner. The power receiver 23 supplies the received power to the electronic device 21 or the battery 22. The power receiver 23 includes a power reception coil, a power reception circuit, and the like. The power receiver 23 is installed on the bottom portion of the cart body 11 so that a power reception surface (i.e., a surface facing a power transmission coil on the power transmitting side) at which the power reception coil receives electric power is parallel to the power transmission surface or the floor surface. The configuration of the control system of the power receiver 23 will be described later in detail.

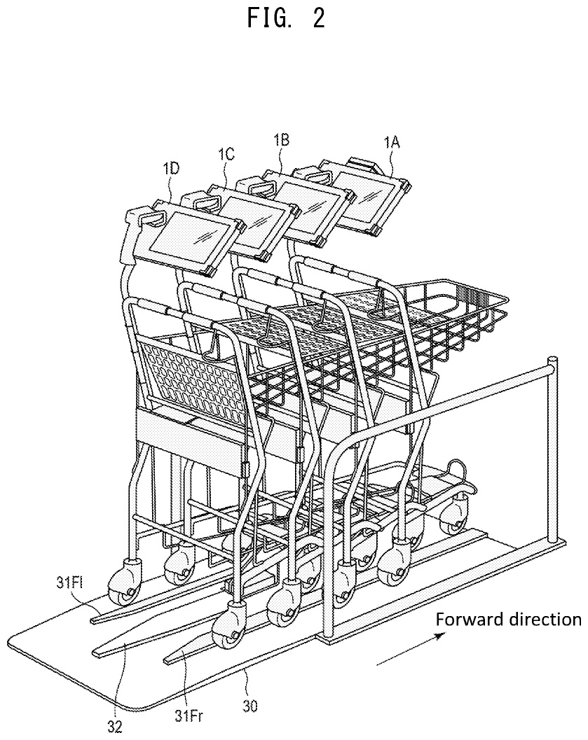

The power receiver 23 is installed on the bottom portion of the cart body 11 so as to receive power transmitted from below the cart body 11. The power receiver 23 receives power output from a power transmitter 40 (see FIG. 2 and the like) installed on an upper surface of a base 30 (see FIG. 2 and the like). The power receiver 23 is installed so that the power reception coil of the power receiver 23 faces the power transmission coil of the power transmitter 40 installed on the base 30.

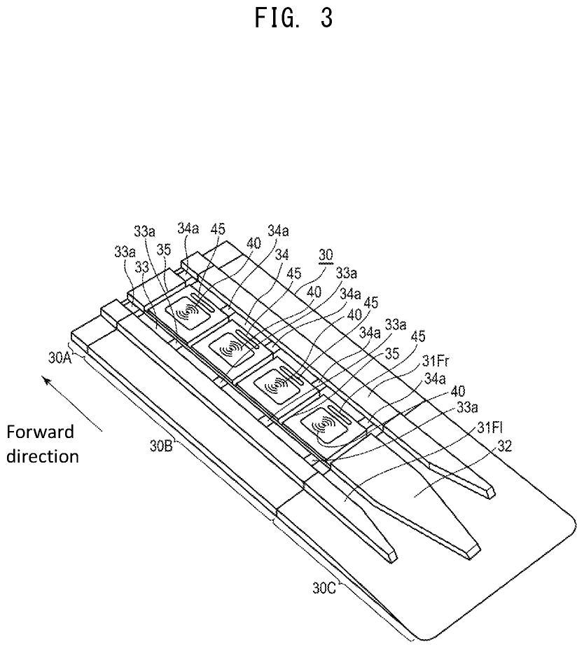

Next, the configuration of the power transmission/reception system including the power transmission system for transmitting power to the power reception system mounted on the cart 1 will be described. FIG. 2 is a perspective view of a plurality of carts 1 each equipped with the power reception system for receiving power transmitted from the power transmission system and stored in a storage position. FIG. 3 is a perspective view of the power transmission system. As shown in FIG. 2, each cart 1 equipped with the power reception system is stored in the storage position. FIG. 2 shows four carts 1 (1A, 1B, 1C, and 1D) stored in the storage position, but the present invention is not limited to this, and five or more carts 1 may be stored in such a storage position and aligned in a row.

On the floor surface in the storage position, the base 30 of the power transmission system is arranged. As shown in FIG. 3, the base 30 includes a base front end 30A, a power transmission base 30B, and a base rear end 30C. The base 30 includes two guide rails 31 (31F1 and 31Fr) for guiding the left and right front wheels 13Fl and 13Fr among four wheels 13 of the stored cart 1, and a guide base 32 between the two guide rails 31. The guide rails 31 and the guide base 32 guide the wheels of each cart 1 towards the storage position. The guide may be any guide as long as it guides the cart to a predetermined storage position.

As shown in FIG. 3, the guide base 32 forms a guide passage 33 with the guide rail 31F1. The guide passage 33 guides the left front wheel 13Fl of the cart 1. In addition, the guide base 32 forms a guide passage 34 with the guide rail 31Fr. The guide passage 34 guides the right front wheel 13Fr of the cart 1. The guide passages 33 and 34 may be grooves formed on the floor surface.

The guide passage 33 has a plurality of recessed portions 33a at predetermined pitches. The guide passage 34 has a plurality of recessed portions 34a at the predetermined pitches. The front wheels 13Fl are engaged with the recessed portions 33a, and the front wheels 13Fr are engaged with the recessed portions 34a. The positions of the recessed portions 33a and 34a will be described later. The recesses portions 33a and 34a engage with the wheels of the cart 1 in order to stop the cart 1 at a predetermined storage position. For example, a bump to which a wheel engages may be provided in the guide passages 33 and 34 instead of the recessed portions 33a and 34a.

In the storage position, the wheels 13 of the carts 1 move along the guide rails 31 such that the adjacent carts 1 are nested. On the near side, the storage basket 12 of the cart 1 has the opening/closing surface 12a, the lower end of which can open and close. Further, on the front end side, the storage basket 12 has the surface smaller than the opening/closing surface 12a. Accordingly, when the rear cart 1B pushes against the opening/closing surface 12a of the front cart LA, the opening/closing surfaces 12a of the front cart LA is pushed up. When the rear cart 1B is further pushed towards the forward direction, the front end side of the storage basket 12 of the rear cart 1B reaches the center of the storage basket 12 of the front shopping cart LA, and those two shopping carts are stored in a nested manner.

Further, the near side of the frame 14 of each cart 1 is formed wider than the front end side thereof. For this reason, the width between the caster 15FR and 15Fl supporting the front wheels 13Fr and 13Fl of the cart 1 is narrower than the width between the caster 15Rr and 15Rl supporting the rear wheels 13Rr and 13Rl. Accordingly, at the storage position, the frame 14 of the rear shopping cart 1B overlaps with the frame 14 of the front cart LA, and thus two or more carts are stored in a nested manner.

As shown in FIG. 3, a plurality of power transmitters 40 are arranged at a predetermined pitch in the guide base 32 provided in the base 30. Each power transmitter 40 transmits power to be received by the power receiver 23 in a non-contact manner. Each of the power transmitters 40 includes an antenna for transmission, a circuit for transmission, and the like. The power transmitter 40 is disposed toward the bottom surface of the cart body 11 so that the power transmission surface (i.e., the surface facing the power reception coil 51 of the power receiver) from which the antenna for transmission (power transmission coil 43) will output electric power is parallel to the floor surface. The power receiver 23 of the cart 1 is installed so as to receive power output from the power transmitter 40 installed on the upper surface of the base 30 when the cart 1 is stored along the guide rails 31. The configuration of the control system of the power transmitter 40 will be described later in detail.

Furthermore, the power transmitter 40 is provided at a position facing the power receiver 23 of each cart 1 stored in the storage position in a nested manner. The front and rear carts 1 are stored in the storage position so as to have predetermined intervals in the forward direction (movement direction) shown in FIG. 2. For this reason, in the storage position, the power receivers 23 mounted on the carts 1 are positioned at predetermined intervals. The power transmitters 40 are arranged at the predetermined intervals along the guide rails 31 so as to face the power receivers 23 of the stored carts 1. The predetermined interval is set so as to coincide with the interval between the recessed portions 33a and 34a as the above described engaged portions. That is, the recessed portions 33a and 34a are arranged so that the front wheels 13Fl are engaged with the recessed portions 34a and the front wheels 13 Fr are engaged with the recessed portions 34a, and the power transmitters 40 and the power receivers 23 face each other.

The stored positions of the plurality of carts 1 (1A to 1D) depend on the shapes of the frame 14 and the storage basket 12. However, there is a possibility that the interval between the front and rear carts 1 stored along the guide rails 31 easily deviates from a predetermined distance depending on the state of the frame 14 and the storage basket 12. For this reason, the recessed portions 33a and 34a are arranged so that the pitch of the guide rails 31 is a predetermined distance. Accordingly, the front wheels 13Fl and 13Fr of the carts 1 stored in the overlapped state are engaged with the recessed portions 33a and 34a, so that the intervals between the front and rear carts 1 become the predetermined distance. As a result, the power receiver 23 of each cart 1 stored in the storage position is disposed to face the power transmitter 40.

Further, as shown in FIG. 3, the base front end 30A, the power transmission base 30B, and the base rear end 30C are arranged in this order from the front along the forward direction. The power transmission base 30B includes a plurality of power transmitters 40 configured to transmit power to the corresponding power receivers of the carts 1. The base front end 30A is connected to the front of the power transmission base 30B in the forward direction. The base rear end 30C is connected behind the power transmission base 30B in the forward direction. The power transmission base 30B may include a plurality of power transmission bases.

Next, the control system of the power transmission/reception system will be described. The power transmission/reception system includes the power reception system including the power receiver 23 installed in each cart 1 and the power transmission system including the power transmitter 40 installed in correspondence with the storage position of the cart 1. That is, the power transmission/reception system is a system in which the power transmitter 40 installed corresponding to the storage position of the cart 1 transmits power to the power receiver 23 installed therein in a non-contact manner (i.e., without any physical and electrical connection). The transmission method is, for example, a magnetic field resonance method, which is a magnetic field coupling method and in which the power transmission can be performed at about 10 to 20 mm between the power transmitter 40 and the power receiver 23.

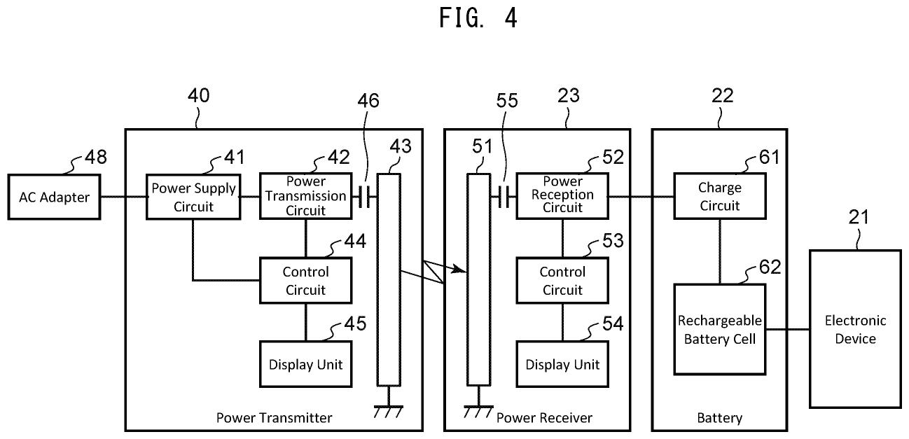

FIG. 4 is a block diagram of a control system of a power transmission/reception system. The power transmission/reception system includes a power transmission side (i.e., the power transmission system) and a system on a power reception side (i.e., the power reception system) for wireless power transmission. The power transmission system is a system for transmitting power to the power receiver 23 mounted in each cart 1 stored in the storage position in a non-contact manner. The power reception system is a system in which the power receiver 23 receives power in a non-contact manner and the battery 22 is charged with the received power.

The power transmission system has the base 30 installed on the floor surface. The base 30 has the plurality of power transmitters 40 installed along the guide rails 31. An AC adapter 48 connected to a commercial power supply is connected to each power transmitter 40. The AC adapter 48 transforms the commercial AC power to DC power and supplies the DC power to the power transmitter 40. The power transmitter 40 operates in one of a power transmission state in which power is supplied to the power receiver 23 and a standby state in which power is not supplied to the power receiver 23.

In the configuration illustrated in FIG. 4, each power transmitter 40 included in the power transmission system includes a power supply circuit 41, a power transmission circuit 42, a power transmission coil 43, a control circuit 44, a display unit 45, a resonance capacitor 46, and the like. Further, each power transmitter 40 is connected to the AC adapter 48.

The power supply circuit 41 is connected to the commercial AC power supply via the AC adapter 48. The power supply circuit 41 converts the voltage of the DC power supply from the AC adapter 48 into a voltage suitable for the operation of each circuit. The power supply circuit 41 generates power and supplies the power to the power transmission circuit 42. Further, the power supply circuit generates power and supplies the power to the control circuit 44.

The power transmission circuit 42 generates transmission power for transmitting power from the power transmission coil 43. The power transmission circuit 42 supplies the generated transmission power to the power transmission coil 43. For example, based on the control of the control circuit 44, the power transmission circuit 42 generates AC power as the transmission power by switching the DC power supplied from the power supply circuit 41.

The power transmission coil 43 outputs the power that can be received by the power receiver 23 in accordance with the power transmitted from the power transmission circuit 42. The transmission surface for transmitting electric power of the transmission coil 43 is formed in a planar shape. The power transmission surface of the power transmission coil 43 is disposed so as to face the power reception surface of the power reception coil 51 of the power receiver 23 in parallel to the floor surface.

For example, the power transmission coil 43 operates as a power transmission resonance circuit by being connected in series or in parallel to the resonance capacitor 46. When the AC power is supplied from the power transmission circuit 42, the power transmission coil 43 as the power transmission resonance circuit generates a magnetic field corresponding to the supplied AC power. The power transmission coil 43 may have a winding structure in which an insulated wire is wound, or may be a coil pattern formed on a printed circuit board.

The display unit 45 is an indicator that indicates a state of the power transmitter 40. The display unit 45 switches the display in accordance with the control of the control circuit 44. For example, the display unit 45 is an LED configured to turn on and off or illuminate in different colors depending on the operation state of the power transmitter 40. Further, the display unit 45 may be a liquid crystal screen configured to display a message indicating the operation state.

The control circuit 44 controls the operation of the power transmission circuit 42 and the display unit 45. The control circuit 44 includes a processor and a memory. The processor executes an arithmetic processing. The processor performs various types of processing according to a program(s) stored in the memory, for example. The memory stores the programs, data used by the processor executing the program(s) and the like. The control circuit 44 may be a microcomputer, an oscillation circuit and the like.

For example, the control circuit 44 controls the display of the display unit 45 in accordance with the state of the power transmitter 40. Further, the control circuit 44 controls the frequency of the AC power output from the power transmission circuit 42 and the operation of the power transmission circuit 42. For example, the control circuit 44 controls the power transmission circuit 42 to switch between a state in which the power transmission coil 43 generates a magnetic field (i.e., the power transmission state) and a state in which the transmission coil 43 does not generate a magnetic field in the power transmission coil 43 (i.e., the standby state). Further, the control circuit 44 may control the power transmission circuit 42 to intermittently generate a magnetic field in the power transmission coil 43 and change a timing of power transmission.

A wireless communication circuit (not shown) for performing wireless communication may be provided in the power transmitter 40. For example, the wireless communication circuit performs wireless communication at a frequency different from the frequency of the power transmission. The control circuit 44 may control each unit by performing wireless communication with the power receiver via the wireless communication circuit. The wireless communication circuit may perform wireless communication at the same frequency as the frequency of the power transmission using a known load modulation technique.

Next, the power reception system will be described. The power reception system includes the power receiver 23 and the battery 22 mounted on each cart 1. The power receiver 23 includes a power reception coil 51, a power reception circuit 52, a control circuit 53, and a display unit 54. The battery also includes a charge circuit 61 and a rechargeable battery cell 62. Additionally, the power receiver 23 may include an output terminal for supplying electric power to the electronic device 21. In such a case, the battery 22 may be charged by electric power supplied through the electronic device 21.

The power reception coil 51 receives the power transmitted from the power transmission coil 43 and supplies the received power to the power reception circuit 52. The power reception surface for receiving electric power of the power reception coil 51 is formed in a planar shape. The power reception surface of the power reception coil 51 is installed on the bottom portion of the cart body 11 in parallel to the floor surface.

For example, the power reception coil 51 operates as a power reception resonance circuit connected in series or in parallel to the resonance capacitor 55 for power reception. When the power reception coil 51 as a power reception resonance circuit is positioned close to the power transmission coil 43 of the power transmitter 40, the power reception coil 51 is electromagnetically coupled to the power transmission coil 43. In the power reception coil 51, a current is induced by the magnetic field generated by the power transmission coil 43 of the power transmitter 40. The power reception coil 51 may have a winding structure in which an insulated wire is wound or may be a coil pattern formed on a printed circuit board.

The power reception coil 51 as the power reception resonance circuit supplies the generated AC power to the power reception circuit 52. In other words, the power reception coil 51 functions as an AC power supply when generating the power from the magnetic field formed by the power transmitter 40. In addition, when the magnetic field resonance method is used for power transmission, the self-resonance frequency of the power reception resonance circuit as the power reception coil 51 is substantially the same as the frequency transmitted by the power transmitter 40. As a result, the power transmission efficiency in the case where the power reception coil 51 and the power transmission coil 43 are electromagnetically coupled to each other is improved.

The power reception circuit 52 converts the power supplied from the power reception coil 51 into power that can be supplied to the battery 22 or the electronic device 21. For example, the power reception circuit 52 rectifies the power supplied from the power reception coil 51 and transforms the rectified power into DC power. The power reception circuit 52 is, for example, a circuit including a rectifier bridge including a plurality of diodes. In such a case, a pair of input terminals of the rectifier bridge is connected to the power reception resonance circuit including the power reception coil 51 and the resonance capacitor 55. The power reception circuit 52 performs full-wave rectification of the received power supplied from the power reception coil 51 and outputs DC power from the pair of output terminals.

The display unit 54 is a display device that displays various kinds of information. For example, the display unit is an indicator that indicates a state of the power receiver 23. The display unit 54 switches the display in accordance with the control of the control circuit 53. For example, the display unit 54 is an LED configured to turn on and off or illuminate in different colors depending on the operation state of the power receiver 23. Further, the display unit 54 may be a liquid crystal screen configured to display a message indicating the operation state.

The control circuit 53 controls the operation of the power reception circuit 52 and the display unit 54. The control circuit 53 includes a processor and a memory. The processor executes an arithmetic processing. The processor performs various types of processing according to a program(s) stored in the memory. The memory stores data used by the processor executing in the program(s). The control circuit 53 may be a microcomputer, an oscillation circuit and the like. For example, the control circuit 53 controls the display of the display unit 54 in accordance with the state of the power receiver 23.

The power receiver 23 may have a wireless communication circuit (not shown) for performing wireless communication with the corresponding power transmitter 40. For example, the wireless communication circuit performs wireless communication at a frequency different from the frequency of the power transmission. The control circuit 53 may control each unit by wirelessly communicating with the power transmitter 40 via the wireless communication circuit. The wireless communication circuit may perform wireless communication at the same frequency as the frequency of the power transmission using a known load modulation technique.

The charge circuit 61 supplies the power supplied from the power reception circuit 52 of the power receiver 23 to the rechargeable battery cell 62 as the charging power. For example, the charge circuit 61 converts the power supplied from the power reception circuit 52 into a DC power used for charging of the rechargeable battery cell 62. That is, the charge circuit 61 converts the power from the power reception circuit 52 into the charging power having a voltage value suitable for charging the rechargeable battery cell 62, and supplies the converted power to the rechargeable battery cell 62. The rechargeable battery cell 62 is charged by the charging power supplied from the charge circuit 61. Further, the rechargeable battery cell 62 is connected to the electronic device 21 and supplies power to the electronic device 21.

Next, the configuration of the power transmission system including the guide that guides the cart 1 to the stop position and the power transmitter 40 that transmits power to the power reception system mounted on the cart 1 will be described. The base 30 forms a guide for storing the cart 1 in a predetermined storage position. As shown in FIG. 3, the base 30 includes the base front end 30A, the power transmission base 30B and the base rear end 30C arranged side by side.

The base front end 30A includes a front end portion of each of the guide rails 31 and a front end portion of the guide base 32, and forms a portion of the guide passages 33 and 34. The base front end 30A is connected to the power transmission base 30B and guides the cart 1 towards a predetermined direction. In the example illustrated in FIG. 3, the base front end 30A has the recessed portions 33a and 34a for stopping the front wheels 13Fl and 13Fr of the cart 1 at predetermined stop positions. Further, the base front end 30A may be provided with a bumper for stopping the front wheels 13Fl and 13Fr of the front cart 1. Alternatively, the bumper may be omitted so that the front cart 1 can be taken out from the cart storage space. In such a case, a slope may be provided between the guide passages 33 and 34 and the floor surface so that the cart 1 can be smoothly taken out towards the forward direction.

The base rear end 30C includes a rear end portion of each of the guide rails 31 and a rear end portion of the guide base 32, and forms a portion of the guide passage 33. The base rear end 30C is connected to the power transmission base 30B and guides the wheels of the cart 1 to the guide passage 33 along the predetermined forward direction. In the example illustrated in FIG. 3, the base rear end 30C has a gentle slope from the floor surface so that the front wheels 13Fl and 13Fr of the cart traveling on the floor surface easily move to the guide passages 33 and 34, and also the rear wheels 13Rr and 13Rl of the cart easily move to the power transmission base 30B from the floor surface. The rear wheels 13Rr and 13Rl are guided to the outside of the guide rails 31Fr and 31F1, respectively.

The power transmission base 30B connects the base front end 30A and the base rear end 30C. The power transmission base 30B includes a portion of each of the guide rails 31 and a portion of the guide base 32. The power transmission base 30B forms the guide passages 33 and 34 by connecting the portions of the guide rails 31 and the portion of the guide base 32 to each of the base front end 30A and the base rear end 30C. That is, the power transmission base 30B guides the cart 1 towards the predetermined forward direction between the base front end 30A and the base rear end 30C. In the example illustrated in FIG. 3, the guide passages 33 and 34 of the power transmission base 30B have recessed portions 33a and 34a as engagement portions for stopping the front wheels of the carts 1 at predetermined stop positions.

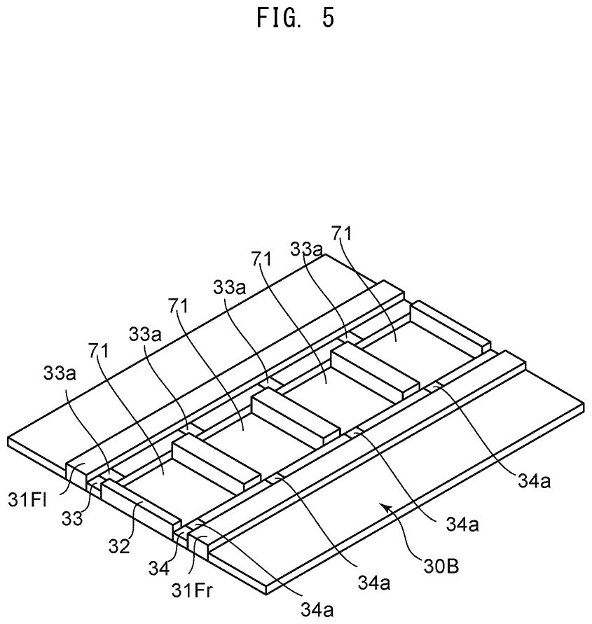

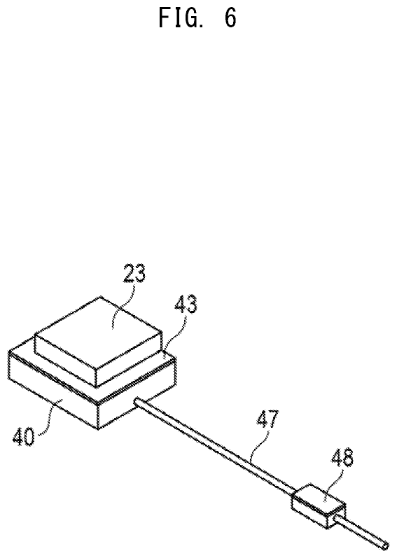

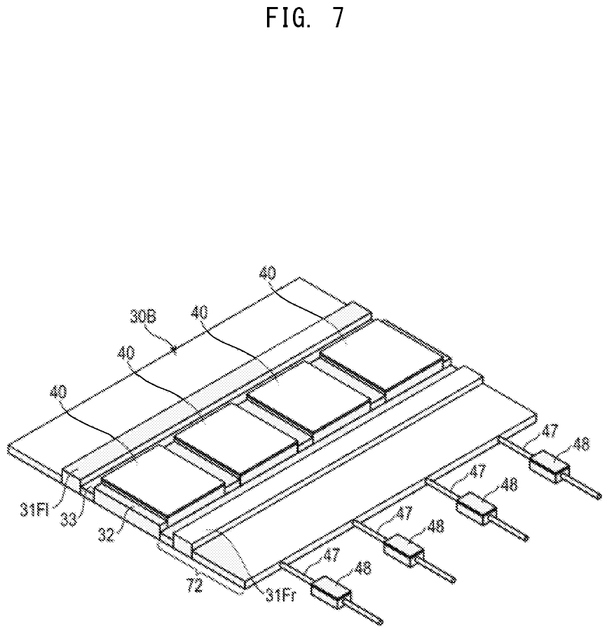

Next, the power transmission base 30B and the plurality of power transmitters 40 attached to the power transmission base 30B will be described in detail. FIG. 5 is a perspective view of the power transmission base 30B to which a plurality of power transmitters 40 are attached. FIG. 6 is a diagram illustrating a positional relationship between the power transmitter 40 to which the AC adapter 48 is connected and the power receiver 23. FIG. 7 is a perspective view of the power transmitter 40 arranged in the power transmission base 30B.

Referring to FIG. 5, the power transmission base 30B includes the guide rails 31 (31F1 and 31Fr), the guide base 32, the recessed portions 33a and 34a, and a recessed portion 71. The guide rails 31 and the guide base 32 are portions of the guide rails 31 and the guide base 32 shown in FIGS. 2 and 3. The guide rails 31 and guide base 32 form guide passages 33 and 34 as guides for moving in the forward direction of the cart 1. The recessed portions 33a and 34a are provided in predetermined positions along the guide passages 33 and 34. The recessed portions 33a and 34a stop the cart 1 in a predetermined stop position by engaging with the wheels of the cart 1.

The recessed portions 33a and 34a as the engagement portions are not intended to firmly fix the front wheels of the cart 1. The front wheels can be moved away from the recessed portions 33a and 34a by pressing the cart 1 with a reasonable degree of strength. For example, provided that the wheel has a diameter of about 100 mm, the recessed portions have a depth of about 2 mm to 3 mm. Further, the engaging portions that engage the front wheels 13Fl and 13Fr are not limited to the structures of the recessed portions 33a and 34a, and may be formed of bumps.

The recessed portion 71 is a mounting part to which the power transmitter 40 is attached. As shown in FIG. 7, the power transmitter 40 is attached to each recessed portion 71 of the power transmission base 30B. The recessed portion 71 is formed so that a housing of the power transmitter 40 fits therein. The recessed portion 71 has a structure so that the power transmitter 40 is detachable. In addition, as long as the power transmitter 40 is detachable, the power transmitter may be attached to the recessed portion 71 with an adhesive, a screw, or the like.

The recessed portions 71 are arranged side by side along the guide passages 33 and 34 in the guide base 32. Each recessed portion 71 is provided at a position facing the power receiver 23 of the cart 1 of which the front wheels 13Fl and 13Fr are stopped at the recessed portions 33a and 34a of the guide passages 33 and 34. In the storage position, the carts 1 move in the forward direction along the guide passages 33 and 34 and stop at predetermined intervals. That is, a plurality of carts 1 are stored in the storage position so as to be continuous at the predetermined intervals by stopping at predetermined stop positions. The recessed portions 71 are arranged side by side at predetermined intervals corresponding to carts which are stored so as to be continuous at predetermined intervals. Accordingly, each recessed portion 71 is located at a position facing the power receiver 23 of each cart 1 which stops at the predetermined stop position.

As shown in FIG. 6, each power transmitter 40 is attached to the recessed portion 71 so that the power transmitter coil 43 faces the power receiver 23. Accordingly, the power transmission coil 43 of the power transmitter 40 attached to the recessed portion 71 of the power transmission base 30B can supply power to the power reception coil 51 of the power receiver 23 in a non-contact manner.

Shown in FIG. 6, each power transmitter 40 is connected to the AC adapter 48 via a cord 47. The AC adapter 48 converts the electric power from the commercial power supply into DC power. The power transmitter 40 supplies the DC power supplied from the AC adapter 48 to the power transmission circuit 42, the control circuit 44, and the display unit 45.

Further, as shown in FIG. 7, the power transmission base 30B may include a detachable part 72. The detachable part 72 may be a cover that covers a portion from the end of the recessed portion 71 to the end of the power transmission base 30B. The detachable part 72 has a structure through which the cord 47 passes between the power transmitter 40 disposed in the recessed portion 71 and the AC adapter 48 disposed outside the power transmission base 30B. For example, a groove for passing the cord 47 connected to the power transmitter 40 may be provided in the detachable part 72.

Further, for example, the cord 47 connected to the power transmitter 40 disposed in the recessed portion 71 is disposed in a predetermined position in a state in which the part 72 is removed. The detachable part 72 is set in the power transmission base 30B as shown in FIG. 7 after the cord 47 is installed in the predetermined position. According to this configuration, the cord 47 connecting the power transmitter 40 and the AC adapter 48 can be stored in the power transmission base 30B, and it is possible to prevent the cord 47 from interfering with the movement of the stored cart 1.

The power transmitter 40 itself may have a function of the AC adapter 48. Further, the AC adapter 48 may be disposed in the recessed portion 71 together with the power transmitter 40, or may be housed in the power transmission base 30B. In the case of these configurations, the detachable part 72 may have a structure for passing the cord 47 for connecting the AC adapter 48 to the commercial power supply. Accordingly, it is possible to prevent the AC adapter 48 and the cord 47 connecting the AC adapter 48 and the power supply from interfering the movement of the cart 1.

As described above, in the power transmission system, a plurality of power transmitters 40 are arranged side by side in the power transmission base 30B provided along the guide passage. Each power transmitter 40 is removably attached to the power transmission base 30B. This facilitates installation of the power transmission base 30B at a cart storage space and installation of the power transmission system including placement of the power transmitters 40 on the power transmission base 30B. Further, since the individual power transmitters 40 can be removed from the power transmission base 30B, maintenance and the like for each of the power transmitters 40 can be easily performed.

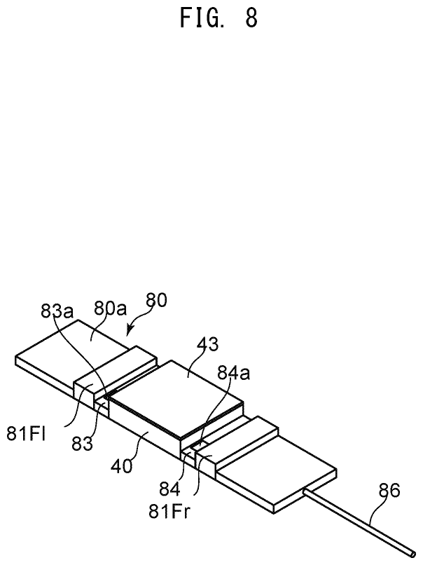

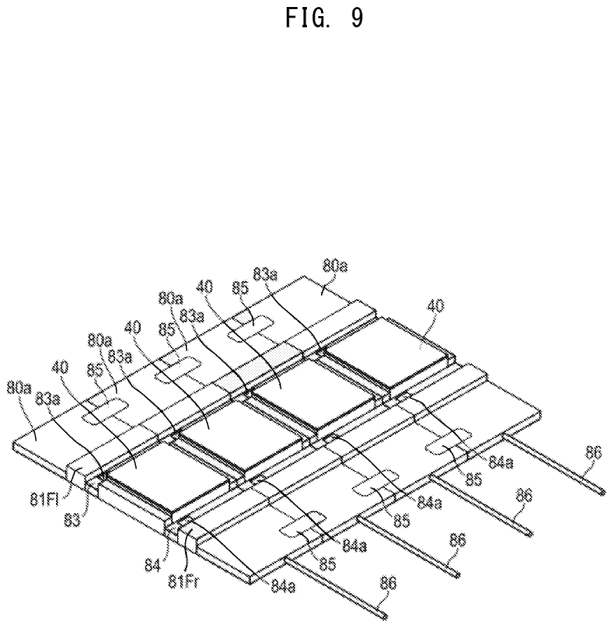

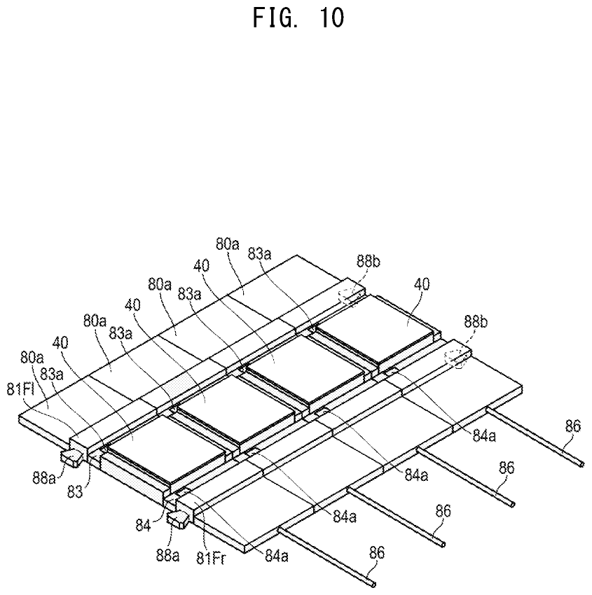

Next, a power transmission system in a modified example will be described. FIG. 8 is a perspective view of a power transmission unit 80 included in the power transmission system. FIG. 9 is a perspective view illustrating a first configuration example of a plurality of power transmission units 80 arranged side by side. FIG. 10 is a perspective view illustrating a second configuration example of the power transmission units 80 arranged side by side.

FIG. 8 is a perspective view of one of the power transmission units 80 in the power transmission system. The power transmission system has a guide and a plurality of power transmission units 80 connected to each other in the forward direction.

As shown in FIG. 8, the power transmission unit 80 includes a base 80a as a base member on which one power transmitter 40 and a pair of guide rails 81 (81F1 and 81Fr) are mounted. For example, the power transmission unit 80 is configured so that the power transmitter 40 is mounted on the base 80a between the guide rails 81. The base 80a may have a structure that allows the power transmitter 40 to be removed or to be fixed. In addition, the base 80a may be formed integrally with the guide rail 81, or may be formed so that the guide rail 81 is attached.

The guide rail 81F1 and one end of the power transmitter 40 form a guide passage 83 serving as a guide for guiding the cart 1 to the stop position by restricting the movement direction of the wheels of the cart 1. Further, the guide rail 81Fr and the other end portion of the power transmitter 40 form a guide passage 84. The guide passages 83 and 84 guide the cart 1 to the stop position by restricting the movement direction of the wheels (e.g., front wheels) of the cart 1.

The guide rails 81F1 and 81Fr forms the guide passages 83 and 84 for guiding the cart 1 to the stop position. For example, the guide rails 81F1 and 81Fr included in the power transmission unit 80 illustrated in FIG. 8 correspond to the guide rails 31F1 and 31Fr shown in FIG. 3. Further, the guide passages 83 and 84 illustrated in FIG. 8 correspond to the guide passages 33 and 34 shown in FIG. 3.

The guide passages 83 and 84 have recessed portion 83a and 84a in predetermined positions. The recessed portions 83a and 84a are engagement portions for engaging the front wheels 13Fl and 13Fr of the cart 1. The cart 1 stops at a predetermined stop position when the front wheels 13Fl and 13Fr are engaged with the recessed portions 83a and 84a. That is, the plurality of power transmission units 80 are provided with the recessed portions 83a and 84a so that the cart 1 stops at a predetermined stop position.

In the configuration example illustrated in FIG. 8, the power transmission unit 80 is configured so that an AC adapter which converts power transmitted from a commercial power supply to the transmitter 40 is incorporated into the base 80a. In the example illustrated in FIG. 8, the base 80a of each power transmission unit 80 is provided with a cord 86 that is connected to the commercial power supply. However, the power transmission unit 80 may be provided with the cord 86 to be connected to an AC adapter disposed outside the base 80a.

FIG. 9 illustrates a first configuration example of a plurality of connection members 85 for connecting the plurality of power transmission units 80. In the first configuration example shown in FIG. 9, each connection member 85 connects adjacent power transmission units 80 so as to connect the guide passages 83 and 84. For example, each connection member 85 is fixed to the base 80a of the front power transmission unit 80 and the base 80a of the rear power transmission unit 80 by using a particular means such as a screw.

FIG. 10 illustrates a second configuration example of a plurality of connection members 88 for connecting the plurality of power transmission units 80. In the second configuration example illustrated in FIG. 10, the connection member 88 of the front power transmission unit 80 and the connection member 88 of the rear power transmission unit 80 are engaged to each other, and the front and rear guide passages 83 and 84 are connected to each other.

As shown in FIG. 10, the connection member 88 includes a first member 88a and a second member 88b provided in front and rear of a base 80a of the power transmission unit 80. The first member 88a and the second member 88b have a structure in which they are engaged to each other. For example, in the power transmission unit 80, the first member 88a is provided at the rear end of the base 80a, and the second member 88b is provided at the front end of the base 80a.

In the example illustrated in FIG. 10, the rear end of the base 80a of the power transmission unit 80 has a convex portion corresponding to the first member 88a of the connection member 88, and the front end of the base 80a of the power transmission unit 80 has a recessed portion corresponding to the second member 88b of the connection member 88. The convex portion as the first member 88a of a power transmission unit 80 and the recessed portion as the second member 88b of an adjacent transmission unit 80 are engaged to each other. By engaging the first member 88a and the second member 88b, the base 80a of the front and rear power transmission units 80 is fixed and connected.

According to the examples shown in FIGS. 8 to 10, the power transmission units 80 each equipped with a power transmitter 40 are arranged side by side to form one guide passages. This facilitates removal of the individual power transmission units 80, thereby facilitating an increase in the number of power transmission units 80, maintenance for each power transmission unit 80, and the like. Further, the front and rear power transmission units 80 are connected to each other by the connection members 88. This makes it possible to prevent an occurrence of a deviation between the front and rear power transmission units 80 even in a configuration in which the individual power transmission units 80 are detachable. As a result, even in a configuration in which the plurality of power transmission units 80 are connected, it is possible to smoothly move the cart 1 by the guide, and it is possible to maintain the accuracy of the stop position of each cart 1. In the above-described embodiments, the shopping cart has been described as an example of a cart equipped with a power reception device that receives power in a non-contact manner. However, the cart 1 equipped with the power reception device is not limited to a shopping cart, and may be, for example, a picking cart or the like used in a warehouse or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power transmission system, comprising:
a base unit that includes a guide rail extending along a first direction for guiding a cart, and a plurality of first recesses separated from each other at first predetermined intervals along the guide rail; and
a plurality of power transmitters attached to the respective first recesses, wherein
each of the first recesses is positioned such that the corresponding power transmitter faces a power receiver of a cart guided along the guide rail.

2. The power transmission system according to claim 1, wherein the base unit further includes a stopper for stopping a wheel of the cart.

3. The power transmission system according to claim 2, wherein the stopper is a bumper disposed at an end of the guide rail.

4. The power transmission system according to claim 1, wherein the base unit further includes a plurality of second recesses separated from each other at second predetermined intervals along the guide rail and each receiving a wheel of a cart.

5. The power transmission system according to claim 1, further comprising:
an adaptor connected to each of the power transmitters via a cable, wherein
the cable is housed in the base unit.

6. The power transmission system according to claim 1, wherein the base unit has a surface that inclines with respect to a floor.

7. The power transmission system according to claim 1, wherein the guide rail includes two rails arranged parallel to each other, and the first recesses are between the rails.

8. The power transmission system according to claim 1, wherein the power transmitters wirelessly transmit power by magnetic field coupling.

9. The power transmission system according to claim 1, wherein the guide rail is configured to permit a plurality of carts to be arranged in a nested manner.

10. The power transmission system according to claim 1, wherein each of the power transmitters includes a display for indicating an operation status thereof.

11. A power transmission system, comprising:
a plurality of transmission units connected to each other in a first direction, each transmission unit including:
a base unit;
a guide rail arranged on the base unit for guiding a cart along the first direction; and
a power transmitter arranged adjacent to the guide rail in a second direction crossing the first direction, the power transmitter including a transmission coil and a power supply circuit configured to supply power to the transmission coil.

12. The power transmission system according to claim 11, further comprising:
one or more connection members that connect two of the transmission units that are adjacent to each other.

13. The power transmission system according to claim 12, wherein the connection members are arranged along the first direction.

14. The power transmission system according to claim 12, wherein the guide rail includes two rails arranged parallel to each other, and the power transmitter is between the rails.

15. The power transmission system according to claim 11, wherein the base unit of each transmission unit includes an engaging member, and two of the transmission units that are adjacent to each other are connected by the engaging member.

16. The power transmission system according to claim 15, wherein the engaging member of each transmission unit protrudes from a side surface of the transmission unit towards the first direction.

17. The power transmission system according to claim 16, wherein the base unit of each transmission unit has a recess with which the engaging member of another transmission unit engages.

18. The power transmission system according to claim 11, wherein the base unit further includes a recess for receiving a wheel of the cart.

19. The power transmission system according to claim 11, wherein the power transmitter wirelessly transmits power by magnetic field coupling.

20. The power transmission system according to claim 11, wherein a connected rail formed by the guide rail of each transmission unit permits a plurality of carts to be arranged in a nested manner.
